(19) United States
(12) Patent Application Publication
(10) Pub. No.: US 2013/0223117 A1
(43) Pub. Date: Aug. 29, 2013

(54) POWER SUPPLY SYSTEM

(71) Applicant: Nishil Thomas Koshy, Ernakulam (IN)

(72) Inventor: Nishil Thomas Koshy, Ernakulam (IN)

(21) Appl. No.: 13/406,923

(22) Filed: Feb. 28, 2012

(51) Int. Cl. H02M 7/04

(52) U.S. Cl. 363/84

(57) ABSTRACT

The invention provides a power supply system that is capable of converting a variable AC voltage to a regulated DC voltage that is configured to be supplied to an associated device. The power supply system includes an AC input load, a rectifier circuit and a voltage limiting circuit. Further the AC input load is coupled in series with the rectifier circuit and the rectifier circuit's output is coupled to the voltage limiting circuit.

### BACKGROUND OF THE INVENTION

1. Field of the Invention

The invention generally relates to a power supply system and more particularly to embedded power supplies for integrated circuits.

2. Description of the Prior Art

Power supply systems described in the prior art comprise a transformer, a rectifier circuit and a filter capacitor. Some of the limitations associated with these power supplies include being bulky, expensive and incurring higher power losses thereby making themselves inefficient. Further, the need for a fixed voltage AC input poses operational constraints.

On the other hand, switched mode power supplies described in the prior art are compact, exhibit high efficiency and can handle variable input AC voltages. However, the switched mode power supplies have complex designs, need custom inductors and introduce high frequency noise in the power supply.

Hence there exists a need for a power supply system that is compact, efficient and yet simple in design from the operational point of view. In this regard, the present invention substantially fulfills this need. In this respect, the power supply system according to the present invention substantially departs from the conventional concepts and designs of the prior art, and in doing so provides an apparatus primarily developed for the purpose of integrated circuits.

### SUMMARY OF THE INVENTION

The above-mentioned shortcomings, disadvantages and problems are addressed herein which will be understood by reading and understanding the following specification. In view of the foregoing disadvantages inherent in the known types of power supply systems now present in the prior art, the present invention provides an improved power supply system, and overcomes the above-mentioned disadvantages and drawbacks of the prior art. As such, the general purpose of the present invention, which will be described subsequently in greater detail, is to provide a new and improved power supply system and method which has most of the advantages of the prior art mentioned heretofore and many novel features that result in a power supply system which is not anticipated, rendered obvious, suggested, or even implied by the prior art, either alone or in any combination thereof.

The invention provides a power supply system that is capable of converting a variable AC voltage to a regulated DC voltage that is configured to be supplied to an associated device. The power supply system comprises an AC input load, a rectifier circuit and a voltage limiting circuit. Further the AC input load is coupled in series with the rectifier circuit and the rectifier circuit's output is coupled to the voltage limiting circuit.

This series coupling of the AC input load and the rectifier circuit results in the AC input load handling the variable voltage in excess of the desired output voltage and also setting a limit on the peak current flowing through the voltage limiting circuit.

The AC input load can be any AC impedance/appliance or an AC capacitor. Further the power supply system may comprise an output capacitor coupled to the voltage limiting circuit. The voltage limiting circuit controls the charging current going to the output capacitor in order to regulate the output DC voltage.

In one embodiment, the power supply system may be embedded into an integrated circuit with the addition of two external parts namely, a series AC capacitor acting as the AC input load and a DC output capacitor.

Systems and methods of varying scope are described herein. In addition to the aspects and advantages described in this summary, further aspects and advantages will become apparent by reference to the drawings and with reference to the detailed description that follows.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved power supply system that has most of the advantages of the prior art power supply systems.

It is another object of the present invention to provide a new and improved power supply system that may be easily and efficiently manufactured and marketed.

An even further object of the present invention is to provide a new and improved power supply system that has a low cost of manufacture with regard to both materials and labor, and which accordingly is then susceptible of low prices of sale to the consuming public, thereby making such power supply system economically available to the buying public.

Still another object of the present invention is to provide a new power supply system that provides in the apparatuses and methods of the prior art some of the advantages thereof, while simultaneously overcoming some of the disadvantages normally associated therewith.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows a schematic diagram of a power supply system configured for a predetermined output load as described in one embodiment;

FIG. 2 shows a schematic diagram of a power supply system configured for a varying output load, as described in one embodiment; and

FIG. 3 shows a schematic diagram of a power supply system configured for a varying output load, as described in another embodiment.

The same reference numerals refer to the same parts throughout the various figures.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

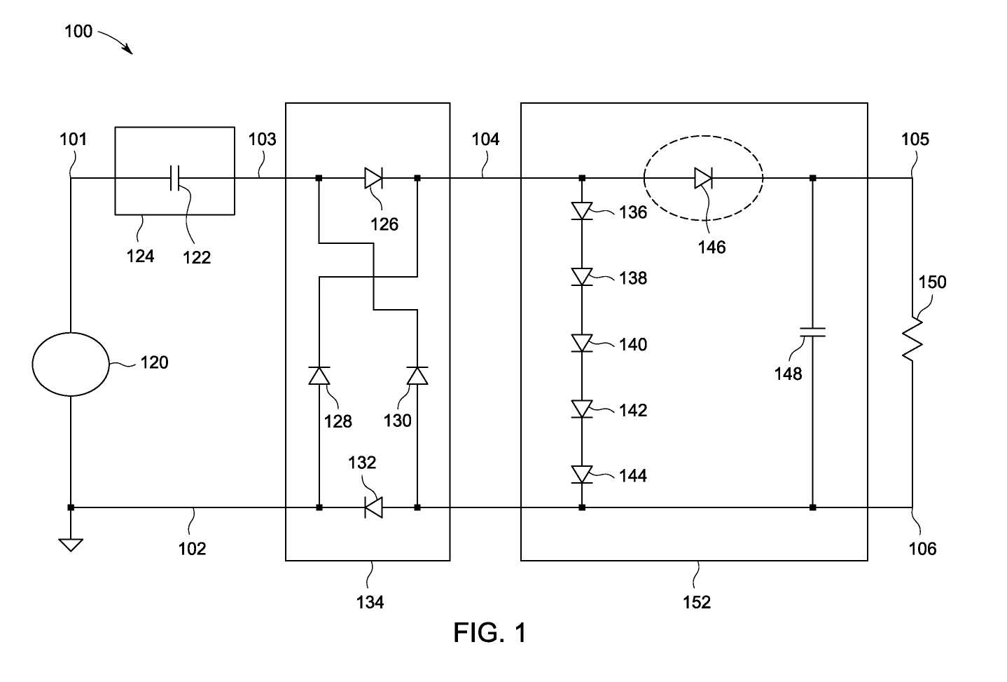

Turning to FIG. 1, an embedded power supply system 100 is provided that converts a variable input alterative current (AC) voltage to a fixed output direct current (DC) voltage, while performing dual function of AC-DC conversion and voltage regulation. Accordingly, the power supply system 100 comprises an AC input load 124, a rectifier circuit 134 and a voltage limiting circuit 152. Further the AC input load 124 is coupled in series with the rectifier circuit 134 and the output of the rectifier circuit 134 is coupled to the voltage limiting circuit 152.

With reference to FIG. 1, when an AC input voltage 120 is supplied between nodes 101 and 102, the power supply system 100 delivers a regulated DC output voltage between nodes 105 and 106. The AC input load 124 is configured for providing the current limiting function, the rectifier circuit 134 is configured for performing AC-DC conversion and the voltage limiting circuit 152 is configured for controlling the output voltage.

The AC input load 124 typically is an AC appliance/impedance which in its simplest form can be an AC capacitor. Further, the AC input load 124 is capable of handing the entire input AC voltage 120. The value of the AC input load 124 is selected based on the desired output current as the maximum AC current that the AC input load 124 will conduct when input AC voltage 120 is applied across its terminals determines the peak DC output load current for the power supply system 100. The rectifier circuit 134 comprises a full wave rectifier circuit that converts the input AC voltage into DC voltage.

In another embodiment, the power supply system 100 described herein can be designed to be an embedded DC power supply system 100 that comprises the voltage limiting circuit 152 that is configured to be customized to optimally supply the voltage and current required by an output load 150 across which the voltage limiting circuit 152 is connected.

The power supply system 100 further comprises an output capacitor 148. The voltage limiting circuit 152 regulates the output voltage by controlling the charging of the output capacitor 148. The regulated DC voltage from the voltage limiting circuit 152 is configured to be supplied to an associated device which in the embodiment is a resistor 150.

In applications where the accurate value of the voltage regulation is not of significance, the simplest implementation of the voltage limiting circuit 152 comprises either a zener diode (not shown) or a series of diodes 136, 138, 140, 142 and 144 (as shown in FIG. 1) with the voltage across its terminals being used to charge the output capacitor 148. The power supply system 100 may further comprise a charge control diode 146 configured to prevent the output capacitor 148 from being discharged through the voltage limiting circuit 152 during the conditions when the input voltage drops below the output voltage. In this configuration, the charging current supplied to the output capacitor 148 automatically reduces when one of the zener diode (not shown) and the diode series (136, 138, 140, 142 and 144) starts conducting. Besides being useful for applications needing a relatively constant DC output load current, this implementation can also be used to generate a regulated AC voltage between nodes 102 and 103.

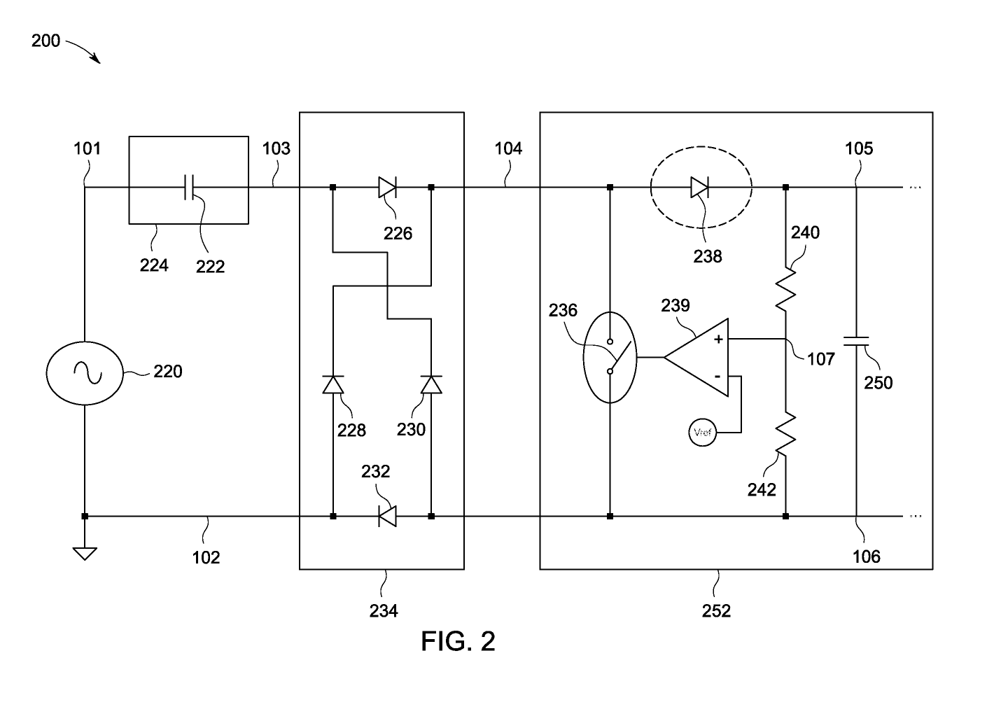

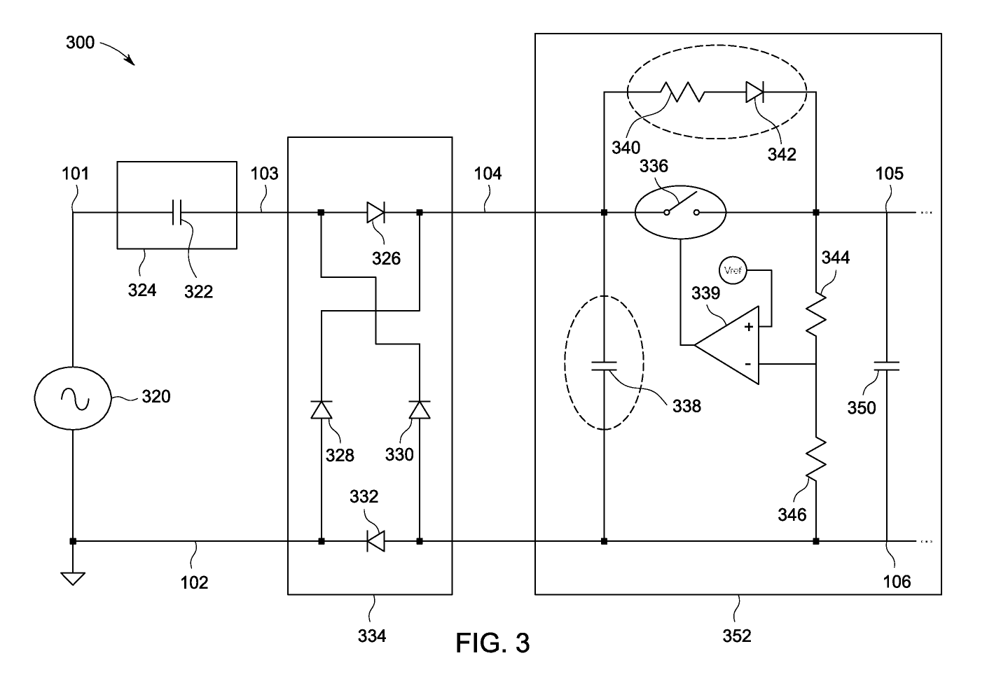

For applications where the output voltage is desired to be controlled in a precise manner or the output load currents can vary significantly in real time, alternative implementations of the voltage limiting circuit 152 are depicted in FIGS. 2 and 3.

Identical components in FIG. 1, FIG. 2 and FIG. 3 are identified by the same reference numerals for the purpose of simplifying the explanation.

Accordingly, in one embodiment shown in FIG. 2, a divided ratio of the output voltage is compared with a preset reference voltage using a comparator 239 to check if the output capacitor 250 is charged to a desired output voltage level. In an alternative embodiment, the combination of the comparator 239 and the reference voltage can be replaced by an opto coupler. Skilled artisans shall however appreciate the replacement of the comparator 239 and reference voltage combination with the opto-coupler is desired when the fine control of the voltage comparison is not warranted or a reduced power-up time is required.

With continuing reference to FIG. 2, the voltage limiting circuit 252 comprises a switching unit for controlling the charging current of the output capacitor 250. The switching unit is connected between the nodes 104 and 106, and is controlled by the comparator 239. The switching unit may comprise a combination of a switching controller 236 and a diode 238 or a dual side switching controller 236 connecting the node 104 to one of the nodes 105 or 106 controlled by the comparator.

The switching controller 236 is turned ON when the DC voltage at the node 107 is higher than the preset reference voltage, and is turned OFF when the DC voltage at the node 107 is lower than the preset reference voltage.

Accordingly, when the output voltage of the output capacitor 250 exceeds the desired output voltage level, the switching controller 236 is closed shorting nodes 104 and 106, preventing further charging of the output capacitor 250. During a condition, when the output voltage reduces due to output load current, the switching controller 236 opens, enabling the output capacitor 250 to recharge to the desired output voltage level. Therefore the switching controller 236 operates in a cyclic manner in order to control the charging and discharging of the output capacitor 250 based on the output load current. Switching controller 236 and diode 238 can also be replaced by a single dual sided switching controller 236 which connects node 104 to one of the nodes 105 or 106 depending on the comparator output.

In yet another embodiment shown in FIG. 3, the switching controller 336 is initially closed and when the output voltage of the output capacitor 350 exceeds the desired output voltage level, the switching controller 336 is opened preventing further charging of the output capacitor 350. The voltage limiting circuit 352 shown in the embodiment may further comprise a combination of a capacitor 338, a resistor 340, and a diode 342 wherein the resistor 340 and the diode 342 are coupled in series and this series coupling in turn is connected to the capacitor 338 through the node 104. The capacitor 338 as shown in FIG. 3 is connected between the nodes 104 and 106. This configuration provides an alternate charging path for the output capacitor 350 which can be used to directly supply the minimum input load current without switching ON the switching controller 336. In cases, where the associated device connected across the voltage limiting circuit 352, requires higher range of output currents, the comparator 339 of the switching unit is configured to control the switching controller 336 in order to provide the charging current while maintaining the voltage across the output capacitor 350 at a desired level.

In one exemplary embodiment, for an input AC voltage of about 220 V and an input load that is selected to be an AC capacitor having an approximate value of about 1 micro farad, the power supply system 100 provides a maximum output current in the range of about 45 to 60 milli amperes across an approximately 5V load depending on the desired load regulation.

Some of the advantages of the power supply systems 100, 200 and 300 described in various embodiments of the invention herein include eliminating the need for transformers, low cost, high efficiency, simple design, capable of handling variable input AC voltages, capable of providing application specific current limiting features and protection from potential output short circuits.

The power supply systems 100, 200 and 300 can be used to enable powering of integrated circuits and other DC electronic systems directly from an AC supply without the need for an AC adaptor.

Further, the power supply systems 100, 200 and 300 can be employed in a feeder circuit for linear voltage regulators in order to improve the overall efficiency of power supplies.

The application specific current limiting feature of the power supply systems 100, 200 and 300 can be used to build low cost power supply systems with very high efficiency for relatively constant loads.

Accordingly, the power supply systems 100, 200 and 300 described herein have varied applications that include being employed as battery chargers, voltage regulators, AC-DC power supplies/adaptors, feeder circuit for linear voltage regulators, embedded power supplies for integrated circuits, AC-DC rectifier circuits and DC power supplies. Skilled artisans shall however appreciate other suitable applications that are not explicitly stated herein.

It is, therefore, apparent that there has been provided, in accordance with the present invention, a power supply system for supplying DC power to a connected load that is fully self-contained and provides an integrated AC to DC power supplying solution. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed as being new and desired to be protected by Letters Patent of the United States is as follows:

1. A power supply system for converting a variable input alterative current (AC) voltage to a fixed output direct current (DC) voltage, while performing dual function of AC-DC conversion and voltage regulation, said power supply system comprising:
an input load configured for receiving AC voltage;
a rectifier circuit coupled to said input load, said rectifier circuit configured for converting said AC voltage to a DC voltage; and
a voltage limiting circuit coupled to said rectifier circuit, said voltage limiting circuit configured for limiting said DC voltage at an output;
wherein the coupling between said rectifier circuit and said input load is a series coupling.

2. The power supply system of claim 1, wherein said input load is an alternative current impedance element further configured for controlling an input current.

3. The powers supply system of claim 2, wherein said input load is an AC appliance.

4. The powers supply system of claim 2, wherein said input load is an AC capacitor.

5. The power supply system of claim 1, wherein said rectifier circuit is a full wave rectifier circuit configured for converting said AC voltage to said DC voltage.

6. The power supply system of claim 1 further comprises an output capacitor coupled to said voltage limiting circuit.

7. The powers supply system of claim 6, wherein said voltage limiting circuit comprises one of a zener diode, and a series of diodes.

8. The power supply system of claim 6 further comprising a charge control diode configured to prevent said output capacitor from being discharged through said voltage limiting circuit during conditions when said input voltage drops below said output voltage.

9. The power supply system of claim 6, wherein said voltage limiting circuit comprises at least one switching unit for controlling a charging current of said output capacitor.

10. The power supply system of claim 9, wherein said switching unit further comprising a switching controller and a diode, said switching controller being configured to close when an output voltage of said output capacitor exceeds a predetermined output voltage level preventing further charging of said output capacitor.

11. The power supply system of claim 9, wherein said voltage limiting circuit further comprises a comparator coupled to said switching unit.

12. The power supply system of claim 9, wherein said voltage limiting circuit further comprises an opto-coupler coupled to said switching unit.

13. The power supply system of claim 6 further comprising a DC-DC voltage regulator coupled to said output capacitor

14. The power supply system of claim 6 further comprising a switching unit coupled to the inputs of said rectifying circuit, said switching unit configured to bypass said rectifier circuit thereby avoiding a supply of charging current to said output capacitor.

15. The power supply system of claim 11 further comprising an additional rectifier circuit, wherein the inputs of said additional rectifier circuit are coupled in parallel with the inputs of said rectifier circuit.

16. The power supply system of claim 15 further comprising a charge storage capacitor coupled to an output of said additional rectifier circuit.

17. The power supply system of claim 16 further comprising a switching unit configured for providing an optional charging path between said charge storage capacitor and said output capacitor.

18. The power supply system of claim 11, wherein said voltage limiting circuit further comprising a capacitor, a resistor, and a diode, said resistor and said diode being coupled in series, and said series coupling being connected to said capacitor.
